(19) United States
(12) Patent Application Publication
(10) Pub. No.: US 2006/0242953 A1
(43) Pub. Date: Nov. 2, 2006

(54) Method and system for exploiting natural pressure differences

(76) Inventor: Gines Sanchez Gomez, Mostoles (ES)

Correspondence Address: SANCHEZ GOMEZ, Ginex, Calle Cervantes, 1, 7°, B, Mostoles, 28932, ES

(21) Appl. No.: 11/117,755

(22) Filed: Apr. 29, 2005

(51) Int. Cl. F16D 31/02

(52) U.S. Cl. 60/398

(57) ABSTRACT

Exploiting natural pressure differences for producing mechanical power, either from the space by generating “vacuum” into a container, or from the sea bottom by generating compressed air, air liquide, or physical-chemical reactions into a container.

### CROSS-REFERENCE TO RELATED APPLICATIONS

The present invention is based on the Spanish application for patent no. P200401236 of May 17, 2005 which is priority.

### BACKGROUND OF THE INVENTION

It is well known the hydroelectric energy which is obtained from pressure differences on a river by means of a dam which raises water level.

### BRIEF SUMMARY OF THE INVENTION

This invention produces methods and means for exploiting the pressure differences between the space or the sea bottom regarding the Earth surface.

In the space case, the pressión difference (1 at.) may be exploited on the Earth surface by means of a closed spatial container provided with a valve. When said container enters to the Earth, the container only has “vacuum”. By connecting an input of a turbine to the atmosphere and connecting an outlet of the turbine to the spatial container, by opening the container valve an air flux is generated, moving the turbine.

In the sea bottom case, the pressión difference may be exploited for example by means of compressed air contained into a immersion capsule or by means of product obtained by means of high pressures. Similarly the spatial case, the immersion capsule of compressed air may be connected to a turbine (the turbine input to the immersion capsule and the atmosphere to the turbine outlet). For obtaining the compressed air, the immersion capsule is submerged to the sea bottom by means of a removing ballast, allowing which sea water floods the immersion capsule, said water compresses the air of the immersion capsule. When the immersion capsule arrives to the sea bottom, a valve separates the compressed air and the sea water of the immersion capsule, then the removing ballast is removed and the immersion capsule returns to the sea surface. By previous the immersion capsule has less average density than the sea water density and the average density of the set of immersion capsule and removing ballast is bigger the sea water density.

Instead compressed air, the immersion capsule may produce air liquid by arranging several consecutive expansion chambers into the immersion capsule, said expansion chambers being provided with isolation valves and cooling devices. Each isolation valve is controlled by the pressure of the previous expansion chamber.

Because water solubility of oxygen and nitrogen are very different, it is possible to use the invention to separate both gases.

Summarizing, it is possible to use the immersion capsule as a high pressure reaction chamber, specially for the product having sea water or air as raw material. So, it is possible to obtaining pressured chloride, pressured hydrogen, ammonia, . . . .

In the space case, the spatial container acts as combustible because raising the spatial container for refilling is economically non-viable, so said spatial container would be a way for importing metals from the space, for example shaped as metal sheet, and said metal sheet shaped as empty cylinders. The metal sheet must tolerate at least 1 at. pressure. An accurate volume for said cylinder is one that the cylinder weight is compensated by the aerostatic vacuum of the cylinder, being:
D diameter of the cylinder
L length
surface π*(D²/2+D*L),
volume π*D²*L/4,
s mass/m² of the cylinder metal sheet,
cylinder mass π*(D²/2+D*L)*s,
average cylinder density 2*s/L+4*s/(π*D),
2*s/L+4*s/(π*D)<=1.29, being 1.29 Kg/m³ air density at the Earth surface level,
said volume of the cylindrical spatial container permits to save braking energy.
   Instead cylindrical spatial container, spherical spatial container may be used, then the ecuation for compensating densities is 3*s/R<=1.29. Another using for said vacuum spatial container is for braking the spatial container: by opening the spatial container at the atmosphere entry, the suction forces generate a braking effect.

In the sea bottom case, the ballast and the sea bottom surface act as combustible. Because the ballast would be stone, rubble, waste, ground, . . . , the combustible would be inexhautible.
Following some energies are depicted:
kinetic energy from 1 m³ of vacuum: 27 Wh,
kinetic energy from 1 Tm of submerged stone at 1000 m: 2,7 KWh,
calorific energy 1 m³ of methane (0.7 Kg): 10 KWh.
   Energy generated according this invention is very far regarding the oil energy, but would be directly used for obtaining movement, liquid air, etc. Also the invention may be used complementary to marine public works as dredging, marine canal, . . . .

### BRIEF DESCRIPTION OF THE FIGURES

FIG. 1. General scheme for obtaining pressure differences from sea bottoms.

FIG. 2. Immersion capsule for obtaining compressed air.

FIG. 3. Immersion capsule control.

FIG. 4. Immersion capsule for obtaining liquid air.

FIG. 5. Immersion capsule for obtaining nitrogen and oxygen.

FIG. 6. Immersion capsule for obtaining ammonia

### DETAILED DESCRIPTION OF THE INVENTION ACCORDING THE FIGURES

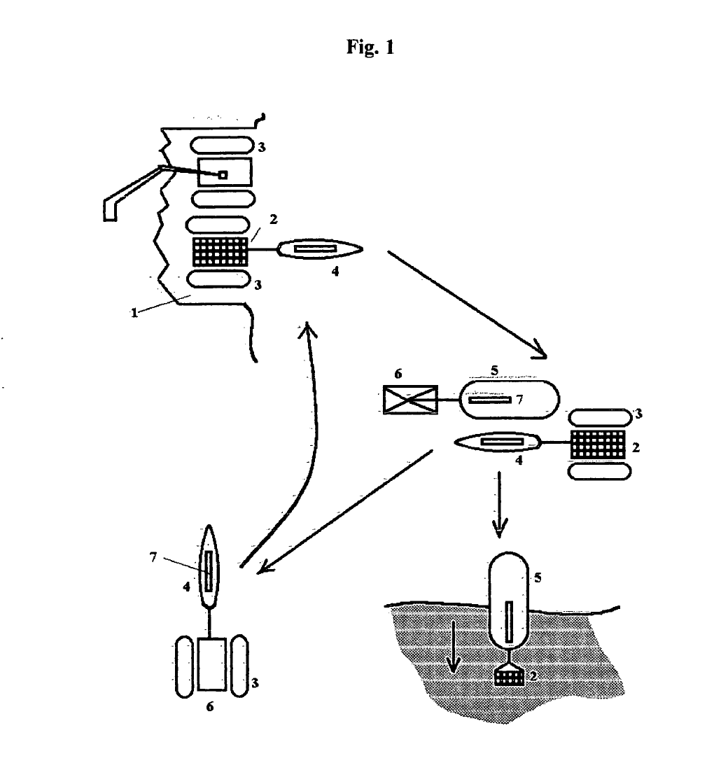

FIG. 1. General scheme for obtaining pressure differences from sea bottoms. In a marine canal work 1 a first ballast container 2 is charged, the ballast container having floats 3 for supporting the ballast. When the first ballast container is filled the same is caught to a tugboat 4 for transporting to the immersion zone, then the first ballast container is released from the tugboat and caught to an immersion capsule 5, and a second ballast container 6 which is empty is recovered from the immersion capsule, also a product container 7 is recovered from the immersion capsule, being changed by an other empty product container, then the floats 3 are released from the first ballast container being connected to the second ballast container, then the immersion container goes to the sea bottom being impelled by the first ballast container. The tugboat transports the second ballast container to the marine canal work, starting the cycle again.

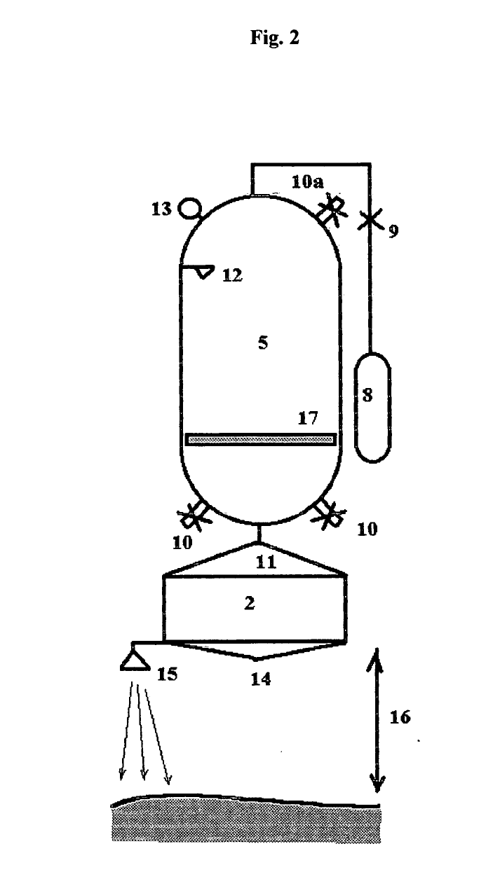

FIG. 2. Immersion capsule for obtaining compressed air. The immersion capsule 5 is provided with a compressed air container 8, a isolation valve 9, one o several flooding/draining valves 10, a levelling pressure valve 10a, a hook 11 from the immersion capsule to the ballast container 2, a water level sensor 12 for measuring the water level into the immersion capsule, and a pressure gauge 13 for measuring pressures outside the immersion capsule.

Furthermore for avoiding air dissolving in sea water at high pressures, the immersion capsule is provided with a separating piston 17. Said separating piston activates the water level sensor 12. The separating piston can have one o several rail-shaft.

The ballast container 2 has a collapsible bottom 14 which is controlled or for the water level sensor or by a gap sensor which is programmed for acting to a prefixed distance 16. When the sea depth is known, the gap sensor may be the pressure gauge 13. Also the gap sensor may be a sonar 15.

Average density of the immersion capsule must be lower than sea water density for floating fullfilled of sea water and with the air compressed container.

The lower zone of the immersion capsule is heavier the upper zone for helping the sea water draining. For draining the immersion capsule, the levelling pressure valve 10a must be opened.

The emptied ballast container must float on sea water.

Also the set of immersion capsule and ballast container are provided with signalizing devices either for the sea surface or underwater and radiolocalization devices specially placed on the immersion capsule.

The valves, collapsible bottom, sensors, . . . they include control devices, control signals and circuits for emitting and receiving said control signals.

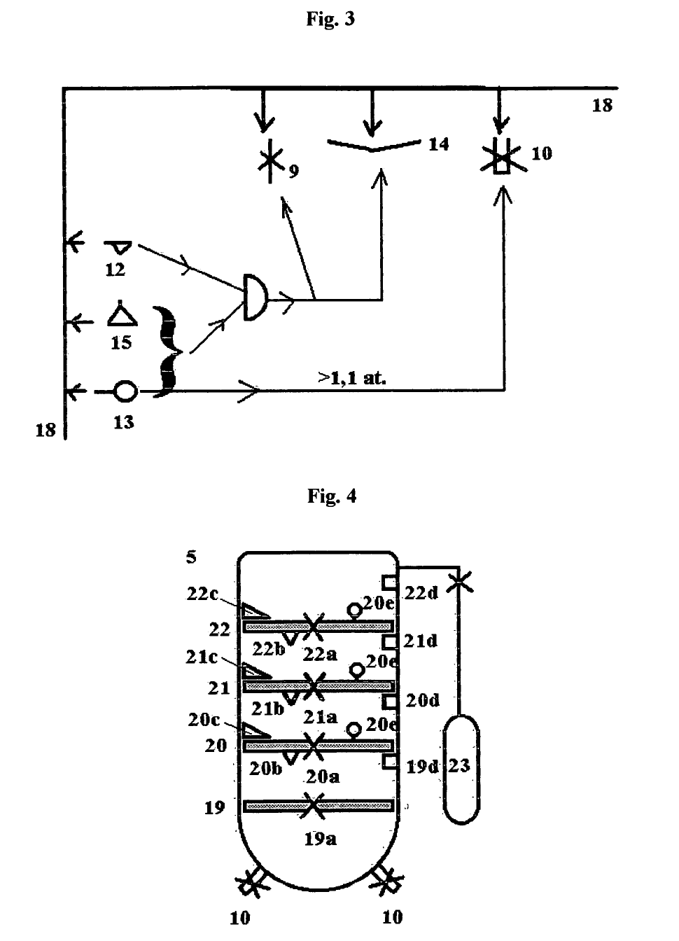

FIG. 3. Immersion capsule control. The isolation valve 9 is opened when the compressed air container 8 is fitted to the immersion capsule 5 and said isolation valve is closed when sea water reaches the water level sensor 12 or the gap sensor is activated.

The collapsible bottom 14 is opened when sea water reaches the water level sensor 12 and the gap sensor is activated.

The flooding/draining valves 10 are opened when the pressure gauge 13 measures a fixed pressure (for example 1.1 at.).

Several electric wires 18 transports the control signals from the gap sensor, the water level sensor and pressure gauge to the isolation valve, the collapsible bottom and the flooding/draining valves.

The control devices may be electronic circuits (AND, OR or NOT doors) or electromechanical (relay).

FIG. 4. Immersion capsule for obtaining liquid air. The immersion capsule 5 has for example four chamber which is delimited by the pistons 19 to 22, each piston being provided with a expansion valve 19a to 22a and with a fixed limit anchorage 19d to 22d, the pistons 20 to 22 are connected each one to a expasion control sensor 20b to 22b, to a limit pressure gauge 20e to 22e and to a movable anchorage 20c to 22c, said movable anchorages for avoiding the inopportunely piston motion.

The expansion valves start being closed.

Either the expansion valves and the movable anchorages are controlled by the expasion control sensors and the limit pressure gauge. So, being i=20 or 21 or 22, when piston i-1 reaches the sensor ib, the valve ia is opened until the limit pressure gauge id reaches a prefixed pressure, then the valve ia is closed, the movable anchorage ic is removed and the valve (i-1)a is opened for passing sea water.

Each fixed limit anchorage limits its linked piston motion, supporting the following piston until which this last piston must be moved.

The walls of the immersion capsule would be heat conductive for taking advantage of the low sea bottom temperature for cooling the compressed air.

At the time of submerging the immersion capsule, the expansion valves must be closed and the movable anchorage must be activated.

According the immersion capsule is submerged, the expasion control sensors are activated, then said expansion control sensors open they associated expansion valves, . . . , so the air is cooled and re-compressed.

Instead the compressed air container a liquid air container 23 is provided.

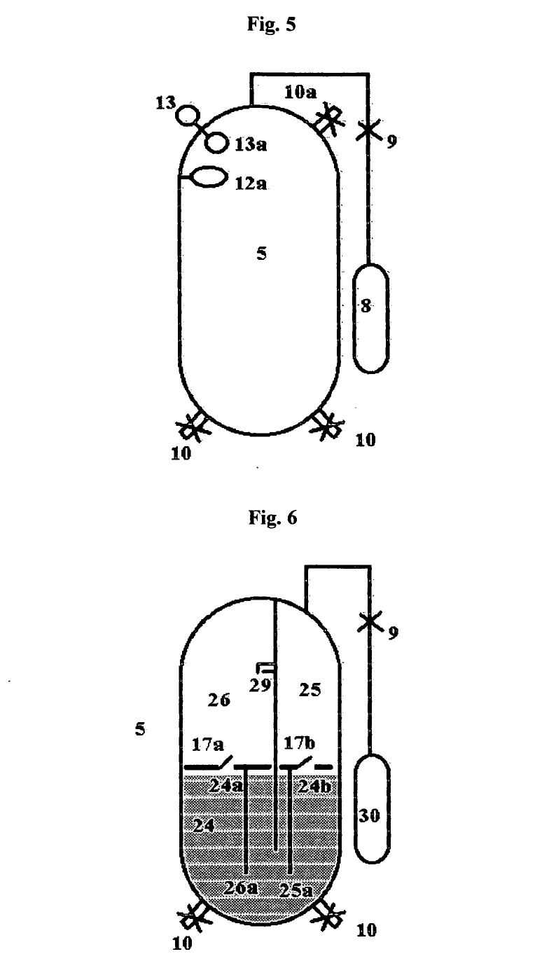

FIG. 5. Immersion capsule for obtaining nitrogen and oxygen. It is very similar the FIG. 2, having the following differences:
the immersion capsule has not the separating piston because the oxygen must be dissolved into sea water,
the water level sensor is a water level buoy 12a,
an internal pressure gauge 13a for measuring water pressure into the immersion capsule,
the walls of the immersion capsule must be strong, because sea bottom pressure is transported to the sea surface.

Functioning is as following:
the flooding/draining valves 10 are opened according the difference between the internal and external pressures obtained from the pressure gauge 13 and the internal pressure gauge 13a, on the way which sea water entry velocity is bigger oxygen sea water diffusion, for avoiding oxygen wasting,
on the sea bottom, the sea water of the immersion capsule contains more oxygen than nitrogen and the compressed air container 8 contains more nitrogen than oxygen (regarding the usual proportion of the air),
when the ballast is released, the flooding/draining valves 10 are closed, so the internal pressure of the immersion capsule is the pressure of the sea bottom, keeping oxygen water dissolved,
nitrogen is removed with the compressed air container,
then the oxygen is obtained through the isolation valve 9 at atmospherical pressure because its solubility decreases with the pressure.

FIG. 6. Immersion capsule for obtaining ammonia. The immersion capsule has three chambers: a sea water chamber 24, a chlorine chamber 25 and an air-hydrogen chamber 26. Furthermore the immersion capsule comprises electrodes 25a and 26a, separating pistons 17a and 17b and separating hatches 24a and 24b.

Sea water is hydrolized for obtaining hydrogen for reacting with nitrogen and oxygen, then the hatches 24a and 24b are closed.

When the immersion capsule reaches the sea bottom, a detonator 29 which is controlled by means of the gap sensor is activate, detonating the mixing of air and hydrogen. Heat, pressure hydrogen and nitrogen produce ammonia.

Chlorine is recovered through the chlorine container 30 at high pressure, and ammonia is recovered at the atmospheric pressure through the isolation valve 9. Also the sea water of the immersion capsule must comprise ammonia and caustic soda.

1. A method for exploiting a natural pressure difference regarding Hearth surface points comprising transporting a container from a point located where said natural pressure difference to the Hearth surface points, inside the container at the natural pressure difference.

2. The method of the claim 1 characterized in that the container is re-usable.

3. The method of the claim 1 comprising being the point located where said natural pressure difference in space, specially manufacturing the container using spatial raw material.

4. The method of the claim 1 comprising being the point located where said natural pressure difference on sea bottom, specially being the container reusable, and previously transporting the container from sea surface to sea bottom by means of a ballast, recovering the container by releasing said ballast.

5. The method of the claim 1 comprising using compressed air for exploiting the pressure difference being the point located where said natural pressure difference on sea bottom.

6. The method of the claim 1 comprising using the pressure difference being the point located where said natural pressure difference on sea bottom for separating at least partially oxygen and nitrogen, by means of greater water oxygen solubility than water nitrogen solubility at high pressures.

7. The method of the claim 1 comprising using the pressure difference being the point located where said natural pressure difference on sea bottom for obtaining liquid air, by means of several steps of compression-decompression.

8. The method of the claim 1 comprising using the pressure difference being the point located where said natural pressure difference on sea bottom for obtaining products obtained from high preassured chemical reactions from products of sea water or air, as chloride, oxygen, nitrogen or hydrogen.

9. The method of the claim 1 comprising being the point located where said natural pressure difference on sea bottom, when a ballast is used for transporting the container from sea surface to sea bottom, being the ballast working wasting from shore sea.

10. A system for exploiting a natural pressure difference regarding Hearth surface points comprising a container, inside the container at pressure of a point located where said natural pressure difference.

11. The system of the claim 10 comprising being the point located where said natural pressure difference in space and specially being the container of spatial raw material.

12. The system of the claim 10 comprising being the point located where said natural pressure difference on sea bottom, specially the container reusable and propelled to sea bottom by means of a removable ballast.

13. The system of the claim 10 being the point located where said natural pressure difference on sea bottom, the container specially reusable and propelled to sea bottom by means of a removable ballast, comprising
an immersion capsule supporting the container through an isolation valve,
the removable ballast being a ballast container having a collapsible bottom, the ballast container linked to the immersion capsule by means of a hook,
the set of the immersion capsule and the ballast container floating on sea water when the ballast container is empty
the immersion capsule provided with one o several flooding/draining valves, a levelling pressure valve, a water level sensor, a pressure gauge and signalizing and radiolocalization devices,
the ballast container provided with a gap sensor as a sonar,
electric wires for control signals from the water level sensor, gap sensor and pressure gauge to the ballast container and the immersion capsule,
the collapsible bottom and the isolation valve controlled by means of the water level sensor and the gap sensor,
the flooding/draining valves controlled by means of the pressure gauge.

14. The system of the claim 10 being the point located where said natural pressure difference on sea bottom and an immersion capsule supporting the container specially reusable and propelled to sea bottom by means of a removable ballast, comprising the immersion capsule initially air fullfilled, a internal pressure gauge, a water level sensor specially a buoy, on sea bottom the container filled with enriched nitrogen air and sea water into the immersion capsule oxygen enriched.

15. The system of the claim 10 being the point located where said natural pressure difference on sea bottom and an immersion capsule supporting the container specially reusable and propelled to sea bottom by means of a removable ballast, comprising one o several pistons for separating sea water from the rest of the immersion capsule.

16. The system of the claim 10 being the point located where said natural pressure difference on sea bottom and an immersion capsule supporting the container specially reusable and propelled to sea bottom by means of a removable ballast, comprising the immersion capsule initially air fullfilled, on sea bottom the container filled with compressed air.

17. The system of the claim 10 being the point located where said natural pressure difference on sea bottom and an immersion capsule supporting the container specially reusable and propelled to sea bottom by means of a removable ballast, comprising
the immersion capsule initially air fullfilled,
the immersion capsule provided with several consecutive chambers, having between two consecutive chambers a piston,
each piston having a expansion valve and a fixed limit anchorage,
one fixed limit anchorage also supporting the next piston,
second an following pistons being associated with an expasion control sensor, a movable anchorage and a limit pressure gauge,
the expansion valves and the movable anchorage controlled by means of the expasion control sensors and the limit pressure gauges,
walls of the immersion capsule being heat conductive.

18. The system of the claim 10 being the point located where said natural pressure difference on sea bottom and an immersion capsule supporting the container specially reusable and propelled to sea bottom by means of a removable ballast, comprising
the immersion capsule having several reaction chambers connected by means of hatches,
the immersion capsule initially fullfilled with a gaz,
the immersion capsule having electrodes for sea water electrolysing,
the gaz specially having nitrogen and oxygen from air and chlorine and hydrogen from sea water.

19. The system of the claim 10 being the point located where said natural pressure difference on sea bottom and an immersion capsule supporting the container specially reusable and propelled to sea bottom by means of a removable ballast, characterized in that the removable ballast is obtained from sea shore by means of quarries and public or private works.

20. An using for exploiting a natural pressure difference comprising producing kinetic energy by means of said pressure difference.
